(19) United States
(12) Patent Application Publication
(10) Pub. No.: US 2014/0279373 A1
(43) Pub. Date: Sep. 18, 2014

(54) SYSTEM AND METHOD FOR PROVIDING HISTORICAL MARKET DATA TO USERS ON A COMPUTER, MOBILE OR HANDHELD DEVICE

(71) Applicant: Shailesh Saraf, Kolkata (IN)

(72) Inventor: Shailesh Saraf, Kolkata (IN)

(21) Appl. No.: 14/237,058

(22) PCT Filed: Dec. 21, 2011
(86) PCT No.: PCT/IB2011/003094

§ 371 Date: Feb. 4, 2014

(30) Foreign Application Priority Data
Sep. 30, 2011 (IN) 1290/KOL/2011

(51) Int. Cl. G06Q 40/04

(52) U.S. Cl. CPC G06Q 40/04
USPC 705/37

(57) ABSTRACT

The present invention relates to a system and method for providing historical market data in a ladder-like display to users accessing the same through a computer, mobile or handheld device. The method involves the steps of: choosing the financial instrument; inputting the price for which the probable upward and/or downward price points is sought; checking anyone, all, or any combination of the time range boxes; choosing the parameter of displaying the results in the ladder in terms of price or date; aggregating and filtering the information according to the search criteria input by a user; displaying the aggregated/filtered data and information on the user's handheld, mobile or computer device; displaying the price, period, support/resistance and breakout levels for each field horizontally and presenting to users a single spreadsheet-like view of key price levels for global and correlated commodities, indices, currencies and bonds.

### FIELD OF THE INVENTION

The invention relates to techniques for providing historical market data in a ladder-like display to users accessing the same through a computer, mobile or handheld device, and in particular to a system and method for displaying historical world market data up to 12 years to users on a mobile device in a classified quick easy-to-view manner (horizontal display of period, price and support for chosen fields of the security of interest of the user) which is filterable and can be quickly assimilated from the bulk of data of different markets, such that the information is usable for correlating securities for the purpose of trading and making investment decisions, the data being provided from a centralized server system connected to several computers storing such data. The invention also includes providing users with a Correlation Ladder Matrix which displays key price levels arranged according to the last traded price/previous close price in a single spreadsheet—like view of correlated instruments across global commodities, indices, currencies and bonds.

### BACKGROUND OF THE INVENTION

The distribution of wealth should shift from the big investor, institutions to the small investor and to guide such small investor to take informed decisions to make money in the financial markets consistently.

Small investors are losing money because they take uninformed and emotional decisions since they do not have access to historical data and cannot strategize while big investors are able to back-test and make strategies on the basis of historical data. The need of the hour is to make available historical data in a concise, precise and comprehensive manner free of cost. The present invention aims to provide such historical data, free of cost, in a manner which enables the small investors to take informed decisions.

Fundamentally markets are of two types:

(a) Range market which can also be identified as a side-ways or a choppy markets or a support/resistance market.
(b) Trending Markets which is also a breakout market and gives a continuous run.

Small investors are not able to identify the type of market because they view small time-frame charts (i.e. 1 min, 15 min, hourly, etc.). Big investors on the other hand view daily, weekly, monthly, quarterly, yearly, etc. charts since historically they have analyzed that the probability of being right in the market is higher with bigger time-frame charts. There is a definite need to guide the small investor in taking the right decision in identifying the different markets by giving levels of bigger time-frame. The present invention provides both support/resistance and breakout levels from daily, weekly, monthly, quarterly and yearly charts so that the probability of identifying the right market is higher.

Globally some markets are highly correlated where movement in one market greatly affects the movement in corresponding correlated market. The small investors are not aware of the concept of correlated markets where in the absence of this knowledge money is lost on a trade in one market due to a movement in another correlated market. Therefore, there is a need to have data to compare markets. The solution according to the present invention provides different ladders and data to compare correlated markets.

The small investors do not have the infrastructure or access to data round the clock and this results in loss of money on account of non-availability of right information at the right time. Hence, the small investor needs to be informed 24*7 and alerted about the critical levels in the market. The present invention provides alerts and notification through email/sms on hand held devices with Android, iPhone, Blackberry and other platforms through compatible applications when the prices touch any important levels.

The financial industry comprising of stock, commodity, currency and bond trading is predominantly electronic in nature. There is a massive growth in volume and volatility in these markets and there is an expressed need to obtain historical market data. The aforesaid markets are closely connected and as such it is imperative to have historical data of all the markets of the world at one place.

There is a perceived lack of system that provides extremely classified historical data which affects the investment decisions of the investors. All the markets affect each other and certain securities have high correlation between them. Due to this there is a need to display historical market prices in a format that is easy to view but also attempts to help view the prices of relevant securities in related markets.

Owing to logistical constraints and/or technical reasons, the investor may or may not be able to have a computer screen in front of him at all times. As a result and due to the sheer enormity and bulk of historical market data of all the markets, there is an express need of investors to have quick access to the same on a mobile/handheld device.

The electronic trading markets are 24-hour markets so there is a great need for handheld mobile devices which display historical data of all the different markets on the go.

Despite the rapid growth of mobile devices running on platforms like Apple's iOS, Blackberry, Symbian and Android, there exists no definite and effective solution that aims to provide what the present invention seeks to provide.

While some marginally effective solutions for providing historical market data already exist, they are difficult to obtain quickly and assimilate in an orderly fashion.

### CURRENT STATE OF THE RELEVANT TECHNOLOGY

U.S. Patent Publication Number US 2008/0103989A1 assigned to Alpes Correctora de Cambio Titulos e Valores Mobilarios Ltda titled “System And Method For Configurably Displaying Market Information For An Asset” relates to market information using opening and closing prices of securities wherein there are weekly, monthly, quarterly and yearly information. However, the present invention relates to historical market data showing high and low prices of securities.

U.S. Patent Publication Number US 2008/0235150A1 assigned to Chicago Mercantile Exchange titled “Market Analytics” relates to an order book, displays real time data and shows market depth and mostly uses the last traded price. However, the present invention relates to historical market data showing high and low prices of securities and does not have real time market data, order book and market depth.

U.S. Pat. No. 7,401,046 assigned to Chicago Board Options Exchange titled “System and Method for Displaying Option Market Information” relates to real-time display of option market data. However, the present invention relates to historical market data and does not have any options data.

U.S. Pat. No. 6,839,686 assigned to DU Long Term Investment Corporation titled “Method and System for Providing Financial Information and Evaluating Securities of a Financial Debt Instrument” relates to order book, displays real-time data and shows market depth. However, the present invention relates to historical market data and does not have real time market data, order book and market depth.

European Patent Publication Number 2315176A1 in the name of Trade Capture OTC Corp. titled “Method and Apparatus for Displaying Market Depth and Other Information on a Mobile Phone, Handheld Device, or Computer System” and European Patent Publication Number 1597651A4 in the name of Trading Tech Int. Inc. titled “A System and Method for Trading and Displaying Market Information in an Electronic Trading Environment” relate to real-time market data. However, the present invention relates to historical market data.

European Patent Publication Number 1597651A4 in the name of Trading Tech Int. Inc. titled “A System and Method for Trading and Displaying Market Information in an Electronic Trading Environment” relates to real-time market data. However, the present invention relates to historical market data.

Most software applications that provide historical market data require the investor to pay considerable amount of fees and charges towards subscriptions and renewals. Such providers include Bloomberg, Thomson Reuters, E-Signal and others. Obtaining historical market data through use of conventional systems is not only cumbersome but also expensive.

Historical market data can also be accessed from websites of financial exchanges. Typically, information available on exchange websites is free in nature. An exchange website will offer data of only those products which are traded on it. Getting data of different instruments from different exchanges would require tremendous and tedious effort for the user, involving several steps.

In view of the drawbacks of present available systems, the solution according to the present invention allows the investor/user to input his invested price, the actual market price or any such price for which he seeks to know the important levels across time frames like year, quarter, month or week.

### SUMMARY OF THE INVENTION

The present disclosure is related generally to systems and methods that enable users to retrieve, filter and view historical market data and information in a meaningful and precise manner.

An exemplary system according to the present disclosure comprises of a server system comprising one or more computing devices that is in communication with one or more data source computer devices.

The server system comprises of one or more load balancers to one or more application servers where market data would be permanently stored and would enable users to retrieve such information from mobiles, handhelds and computers.

The information stored in the application server system is aggregated and filtered according to one or more user-initiated commands. The aggregated/filtered data and information are then displayed on the user's handheld, mobile or computer device.

The first entry into the interface would initiate a login page where the solution requires a registration and entry of the-user's email account and password. The user can also optionally login through Facebook and/or Gmail.

Preferably a caution to investing in securities would forewarn the user and communicate the market risks associated. This would appear in the interface after the successful log in by the said user. The user necessarily will have to accept the undertaking that he has read and understood clearly, fully and completely the matter contained therein.

The top portion of the interface would provide for icons and links that may correspond to the owners of the inventive solution, description of the company and disclaimer for the website. It may also have icons that make the user navigate out of the interactive page and change his authentication password.

Notably, the historical market data and information is provided and displayed to the user on a simple, single tabular structure, hereinafter known as a “ladder”. Preferably the interactive interface comprises of a single display screen capable of accommodating eight ladders capable of displaying historical market data. The methods would be applicable to one or all of the ladders.

Preferably, the user specifies the security and this automatically invokes a drop down auto-complete box to facilitate faster typing and input.

Preferably, the user then specifies his price for the security.

Preferably, the user can click on the refresh button in the ladder to update delayed market data for the selected instrument.

Preferably, the user can choose to sort the contents of the ladder by price or date.

Preferably, the user has the options to display results in the ladder based on time parameters like week, month, quarter or year, individually or in combinations thereof.

Preferably, the user can click on the Dynamiclevels checkbox to generate levels in accordance to the solution's in-house research knowledge and logic.

Preferably a pop-up would be generated by pointing on the price point period, rendering the date when that particular price point was reached.

Preferably the default display of the ladder would reflect a total of at least five immediate price points, above and below, for the queried price of the security.

Preferably the ladder would comprise of a scrolling mechanism. The function to scroll the ladder would enable the user to access a longer list of entries on limited sized display screens. As a result of including such a scrolling mechanism, any amount of data and information may be accessed and viewed on a single interactive interface, regardless of the size of the display area.

Notably, market data and information of correlated global financial instruments is provided and displayed to the user on a simple, single spread-sheet like structure, hereinafter known as the “Correlation Ladder Matrix”.

A mobile communication device in accordance with the present disclosure runs this inventive solution from an application to access and retrieve market data stored on the application servers. Also included in the mobile application are one or more input fields for retrieving user-specific information in the ladder. Optionally, the mobile communication device may include a touch-screen, whereby a user may provide user inputs via the touch screen.

The application running the solution in the exemplary mobile communication device would enable the communication device to generate and display an interactive interface. The user would then need to specifically filter for the information sought and the ladder for the desired data would then be shown. Displayed in the ladder may be up to twelve years of historical market data.

Preferably the one or more input devices comprises the display screen, said display screen being a touch-screen configured to process and interpret a user's contact with said display screen as user inputs.

The invention is designed to display historical market data up to 12 years. The invention lies in sourcing, accumulating, collating, processing and presenting the data on various platforms in a secure and interactive way. The invention can be accessed from both computers and handheld devices. The display of price, period, support-resistance and trend is in a numerical and vertical format. There is no compression of data stream between the application server and the computer/handheld device. The query input by the user executes a runtime command on the application server and this makes the historical data quickly accessible.

### BRIEF DESCRIPTION OF THE ACCOMPANYING DRAWINGS

FIGS. 1 and 2 give a pictorial view of historical market data on a computer screen according to an embodiment of the invention.

FIG. 3 is a ladder-like display of historical market data in numerical form according to an embodiment of the invention.

FIG. 4 is a schematic diagram of the components comprising the server system according to the present invention.

FIG. 5 is a flowsheet for data sourcing, storing, processing and displaying according to an embodiment of the invention.

FIG. 6 shows a typical end-of-day (EOD) data appended in a tabular format.

FIG. 7 shows a vertical scrolling mechanism acting on a ladder with 11 rows.

FIG. 8 shows the first field in a ladder.

FIG. 9 depicts the manner of inputting data.

FIG. 10 depicts the method of sorting the price levels of the ladder in terms of date or price.

FIG. 11 shows the manner of zooming in on a particular ladder.

FIG. 12 shows the hardware arrangement required for implementing the solution according to an embodiment of the invention.

FIGS. 13 and 14 show a tabular formatted interactive interface comprising a display screen accommodating eight ladders with scrolling function.

FIG. 15 shows the field below the global instrument search box in which a user fix a price for his security of interest.

FIG. 16 shows the check-boxes below the price section corresponding to weekly, monthly, quarterly or yearly price levels.

FIGS. 17 to 19 depict the functioning of the global instrument search box.

FIGS. 20 to 21 show how the display of historical data is achieved on mobile devices.

FIG. 22 shows a typical display of the correlation ladder matrix.

FIGS. 23 and 24 show typical web pages showing the degree of correlation of various instruments under Global Indices, Global Currencies, Bonds, and Base Metals.

FIGS. 25, 26, and 27 display correlation ladder matrix with tabs for indices, commodities and currencies, respectively.

FIGS. 28, 29, and 30 give the full view of respective correlation ladder matrix for indices, commodities and currencies individually on selection of the respective tabs.

FIG. 31 shows a consolidated view of the correlation ladder matrix.

FIG. 32 depicts the scrolling mechanism.

FIG. 33 shows the display of the date of the price level as a tooltip in a ladder.

FIG. 34 shows the functioning of the Global Instrument Search Box in a typical ladder.

FIG. 35 shows the use of a Blackberry device to access data for the solution.

### DETAILED DESCRIPTION OF THE INVENTION

In FIGS. 1 and 2 of the appended drawings: a)—The user types his security of interest and an auto-complete box drops down as he types for faster input.

b)—The user then inputs his price for which he seeks the probable upward and/or downward price points. By default, this field shows the previous trading day's closing price.

c)—The user can check a single, all, or any combination of the time range boxes. Y denotes Yearly, Q denotes quarterly, M denotes monthly and W denotes weekly price points.

d)—The user can click on the Dynamiclevels checkbox to generate levels in accordance to the solution's in-house research knowledge and logic.

e)—This segment is what is known as the ladder of the inventive solution. The price, period and support/resistance for each field are displayed horizontally. If the chosen number of results increases the size of the ladder, a scrolling mechanism would automatically be initiated for the relevant ladder enabling the user to access longer lists of entries.

The present invention allows users to input a price of the security. The results are displayed as per the user's selected criteria and price. The user can input the current price of an instrument and accordingly obtain the next important price levels, above and below the current price. The user can also input the price at which he bought/sold a security and generate the subsequent important price points from his point of purchase/sale price. By default, the previous day's closing price for a chosen security would be displayed in the ladder. In case the user is subscribed to delayed data, then the user can see the delayed market price.

The invention allows the user to view historical market data in numerical form contained in a ladder-like display as shown in FIG. 3.

The invention provides users with historical high and low prices of securities generated from daily, weekly, monthly, quarterly and yearly price charts. Not only does historical market data help to look at the number of different trends that may have occurred in the recent past, it can also help to formulate an idea of how things may work in the near future. Most people don't understand the ins and outs of exactly what is going on in the market which is why historical market data can be a good indicator of which direction the market is heading in. By making the bulk of historical market data easily available and understandable, there are high chances of a user to get a well-rounded outlook of the general market or own investments. The price levels obtained from daily, weekly, monthly, quarterly and yearly charts are found to somewhat probabilistic in nature for estimating future prices.

The user can access historical market data which is updated every day. Some users may be interested to use the levels with delayed market data. The technical solution can be integrated with a data provider, in which the user is supposed to subscribe for the data services. For example, the user may have access for delayed live feed for US, European, Indian, Singapore, Hong Kong, and other markets depending on the linkages to data providers for those markets.

Just like Google allows users to instantly get information by searching through its enormous database free of cost, the present invention allows the investor to look up his security of interest across all the globally traded selected instruments, instantly and free of cost.

The solution can be provided both on computers and hand-held devices. The solution may be ported on different platforms in future. The present invention has multiple embodiments in which display can be provided on mobile phones running on different platforms (android, windows, apple, blackberry) as shown in the schematic diagram (FIG. 4). The solution can be accessed through desktop computers and handheld devices running on platforms like Apple, Android, Blackberry. These devices will make HTTP requests to the server system. The requests received by the server system would be handled by a Load Balancer instance, which will route such requests to one or more application servers, running in parallel and in Master-Slave mode, depending upon the load of requests and other defined parameters. The Application servers would accept the requests and return processed data from the database servers. The information stored in the application server system is aggregated and filtered according to the search criteria input by the user. The aggregated/filtered data and information are then displayed on the user's handheld, mobile or computer device. The entire server systems and configurations would be hosted in a cloud-based or dedicated server hosting environment, protected by suitable hardware and software firewalls.

No monetary transaction is involved for a user to subscribe to the solution. The invention displays historical market data of financial instruments and can be used to view delayed market data, as disseminated by a licensed data provider. It may be envisaged to allow live market data to be accessed. If this feature is enabled, the user may have to register with the licensed data provider in return for a fee, which the user may need to directly pay to the data provider.

The technical advantage of the invention is evidenced by the solutions provided to four concrete technical problems as discussed below:

Technical Problem 1—Availability, Size and Cost Traditionally, stock markets were restricted to large institutional investors, funds, countries, banks and large companies. These institutions usually had technical analysts who would back test historical data to create trading strategies. Since the early 1990s, the Internet increased the number of home brokers and small investors. These small investors and home brokers had only access to newspapers, magazines and other periodicals or were dependent on technical analysts to provide them with historical data, support and resistance of the market.

Even with all of the information mentioned above, private and small investors perhaps had no access to sufficient, complete and precise information to make safe investments. In addition, perhaps the user did not know how to work with complex analytical information. Different technical analysts guide investors differently based on the plurality of charts available in the market. Most analysts use one, five, ten, fifteen and thirty minute charts and some use one, one-twenty and two-forty minute charts. Investors need high skill and training to understand the various charts. The enormity of historical market data of globally traded financial instruments is so large that obtaining such data would require tremendous and tedious effort for the user, involving many steps.

Obtaining historical market data through use of conventional systems is not only cumbersome but also expensive. Most software applications that provide historical market data require the investor to pay considerable amount of fees and charges.

### Solution:

Small investor intent is to receive historical market data in an easy and effective way, which would not require high skill, training and is free of cost. The present invention can be used from handheld devices and computers making it convenient for small investors to have quick and on the go access to world historical market data.

The small investor may not be able to understand the various charts so the data is being provided in a numerical form in a ladder showing the resistances and supports of the market. The invention seeks to provide those price levels to the small investors which have the capability to be a crucial point for: (a) entry and exit, and (b) changing the existing trend in the market by breaking the price level. The price levels obtained from daily, weekly, monthly, quarterly and yearly price charts have higher probability of creating effective entry and trend reversal points as opposed to smaller time frame charts (minutes and hours). Key price levels obtained from daily charts can be effectively used to create trading strategies for the short term. When a security's price has fallen to a level where demand at that price increases and buyers begin to buy, a support level is created. When a security's price rises to a level where demand decreases and owners begin to sell to lock in their profits, a resistance level is created. It is strongly believed that the high and low are the two most important price points of a security. The high and low of an instrument for a given time lends a probabilistic nature for knowing future price levels. The more times that a security bounces off support and falls back from resistance, the stronger these support and resistance levels become. Some securities become so entrenched in this trading range, that they eventually have a hard time breaking through the levels either on the up or downside. When it does, the security moves out of its price range and a breakout occurs in the direction of the movement that takes place. Historical market data provided by our invention is absolutely and unconditionally free for the user. The user, at his option, may chose to view delayed market data from the invention by subscribing to the data provider for a fee.

### Technical Problem 2—Sideways or Trending Market

A sideways market is a market where the price is moving back and forth between a higher price and a lower price. The higher price would be acting as resistance because it prevents the price from moving above it, and the lower price would be acting as support because it prevents the price from moving below it. The price range of a ranging market can be small or large, and if the range is very small the market would be considered to be choppy (moving sideways with very little upward or downward movement).

A trending market is a market where the price is moving in a single direction, either up or down, but not sideways. There may be several small price reversals, but nothing large enough to prevent the price movement from continuing in its original direction. A day trading trend may last for a few minutes or a few hours, and longer term trends may last for several weeks or months.

Most investors get stuck with shorter duration charts when the market changes its range. Price levels, typically known as breakouts, are more accurately delivered from longer duration charts. If investors do not have proper awareness of breakout levels, they may suddenly find themselves trapped in an undesirable situation.

### Solution:

The present invention clearly displays key price levels from which a breakout might take place. Having this information displayed in the ladder, the investor can increase his awareness about a likely market change. By doing this, he would reduce his emotions and be more objective about his investments and market outlook. To guide the small investor in taking the right decision in identifying the different markets by giving levels of bigger time-frame, the invention gives both support/resistance and breakout levels from daily, weekly, monthly,quarterly & yearly charts so that the probability of identifying the right market is higher.

### Technical Problem 3—Correlation

The global financial industry comprising of stock, commodity, currency and bond trading is predominantly electronic in nature. The aforesaid markets are closely correlated and as such it is imperative to have all the different markets of the world at one place. All the markets affect each other and certain securities have high correlation between them. The trends and levels of one instrument can be a major factor of one instrument can be a major factor in understanding the trend and levels of it relational instrument. As for example, stock market indices like The Dow Jones Industrial Average Index (DJIA) and FTSE are strongly and positively correlated. In commodities, bullion metals comprising of Gold and Silver and base metals comprising of Copper and Zinc are found to have over 70% positive correlation between them.

### Solution:

There is an expressed need to compare historical data of two or more instruments which are highly correlated. There is a need to display historical market prices in a format which is not easy to view but also attempts to help view the prices of relevant securities in related markets. The invention provides a “Correlation Ladder Matrix” which presents to users a single spreadsheet—like view of key price levels for global and correlated commodities, indices, currencies and bonds. The Correlation Ladder Matrix gives an instant one-shot view of the financial movements ensuing across the globe and allows the investor to take decisions accordingly. Additionally, the invention allows the user to add multiple ladders in a single screen and this feature can be extensively used for comparing key price levels of related instruments like those mentioned above. The user can view up to eight ladders in a single computer display screen.

Technical Problem 4—24 hour markets

Global electronic trading markets are typically 24 hours markets and there is massive volume and volatility in these markets. Owing to logistical constraints and/or technical reasons, the investor may not be able to have a computer screen in front of him at all times. Due to the sheer enormity and bulk of historical market data of all the markets, there is an expressed need of investors to have quick access to the same on a mobile/handheld device.

### Solution:

The present invention provides investors to obtain historical market data of all markets on handheld devices made by, Apple, Blackberry and Android. The user can optionally choose to receive alerts when the prices touch important levels.

The improved technical effects and contribution over conventional prior art is as enlisted below:

1) Collection and programming the huge database
2) Programmed and automated daily update of the database
3) Presenting the historical high and low prices on a numerical, ladder like format
4) Capability of adding ladders and comparing levels of different financial instruments
5) Executing a runtime command on the application server to retrieve historical market data quickly

### Data Sourcing, Storing, Processing and Displaying

The invention lies in the combination of hardware and software, as explained below. As can be seen from FIG. 5, the steps of the process are:
a. An application has been developed to act as an interface between Bloomberg or other data providers and Dynamic Levels database.
b. That application is scheduled to run on the database server at a predefined time everyday.
c. Once activated, that application presently connects to Bloomberg through the Web Service Certification called ‘Bloomberg Data License’.
d. After connecting, it sends a request to Bloomberg/others to provide EOD (End of Day) data for all the securities (as listed in the Database) as per a specific format.
e. Upon processing of that request, Bloomberg sends the required data, which the application subsequently inserts in the Database.
f. The whole process is repeated every day (except Mondays) to keep the Database updated.
   The historical data is stored in a single MySQL Table in the Database. The following information is stored in the table:
a. Security Name.
b. Date.
c. Opening Price of that security on that date.
d. Highest Price of that security on that date.
e. Lowest Price of that security on that date.
f. Closing Price of that security on that date. EOD data (downloaded every day except Monday) is appended on that table (FIG. 6).

### Scrolling Mechanism

Preferably the ladder would comprise of a vertical scrolling mechanism. The ladder will typically show a maximum of 11 rows (1 row for ‘Price’+5 rows for Resistance Levels+5 Rows for Support Levels) in case of Desktop/Laptop systems, and 9 rows in case of Mobile Devices, at a time. If and when the user wishes to see more levels than the default ones (5 for desktop/laptop and 4 for Mobile devices), he can use the vertical scroll bar. The function to scroll the ladder would enable the user to access a longer list of entries on limited-sized display screens. As a result of including such a scrolling mechanism, any amount of data and information may be accessed and viewed on a single interactive interface, regardless of the size of the display area (FIG. 7).

### Ladder

In each ladder, the first field is the global instruments search box in which the user inputs the name of the instrument for which he seeks to know the price levels. The user must input at least three characters of the instrument's name to automatically invoke suggestions via a drop down menu. The menu so invoked would show lesser and lesser suggestions as the user types more and more characters of his instrument's name (FIG. 8).

Referring to FIG. 9, below the global instrument search box, on the left, would be a field in which the user inputs a price for his security of interest. Only numerical characters are allowed for entry into this field. For querying currency instruments, the user can specify numerical values having up to four decimal points and two decimals for any other class of instruments. By default, the previous day's closing price for the instrument selected would be shown in the price field. By hovering over this field using a pointing peripheral, a tool tip would be displayed saying “Enter your price, by default it shows the close price of the last trading day. You also have an option of putting your price for the chosen instrument so that you can view the levels close to your invested price”.

On the field to right of the price field, the user can click on the refresh button to update delayed market data being displayed in the ladder for the chosen instrument.

Referring to FIG. 10, typically, the default view would always display 5 levels above and below the user's input price, displaying a maximum of 11 rows−(1 Price row+5 Support Levels+5 Resistance Levels) at a time for a computer/laptop screen and a maximum of 4 levels displayed on 9 rows−(1 My Price row+4 Support Levels+4 Resistance Levels) at a time for handheld devices.

Preferably the ladder would comprise of a vertical scrolling mechanism. The function to scroll the ladder would enable the user to access a longer list of entries on limited-sized display screens. As a result of including such a scrolling mechanism, any amount of data and information may be accessed and viewed on a single interactive interface, regardless of the size of the display area.

Below the Price section, the user can use the “Sort by” option to view results displayed in terms of “price” or “date”.

The ladder shows values greater than the specified price in an ascending order above the user's price. Conversely, the ladder shows values lower than the specified price in a descending order below the user's price. This arrangement, both for rows above and below the user's price is arranged chronologically, only if the user selects to sort the ladder by “date”. When the Dynamiclevels checkbox is unchecked and the ladder is sort by “price”, the ladder will show only those levels corresponding to checkboxes marked against W, M, Q, Y (which may be marked individually or in combinations thereof)

Below the Sort By option, there would be five check-boxes “W”, “M”, “Q”, “Y” and “Dynamiclevels” in which the user places a tick on any one, all, or any combination against the said checkboxes. “W” corresponds to weekly price levels, “M” corresponds to monthly price levels, “Q” corresponds to quarterly price levels, “Y” corresponds to yearly price levels and “Dynamiclevels” corresponds to levels as per the in-house research knowledge. By default, all check-boxes would be tick marked.

The scheme for accessing data for the security of interest for the solution is given below:

| Symbol | Description |
|---|---|
| Enter your search | Enter your search, field where one can search for any Bonds, |
| | Commodity, Currency, Indices and Stocks etc. that are traded globalty. |
| Enter your price | Enter your price, by default it shows the close price or the last trading |
| | day. You also have an option or putting your price for the chosen |
| | instrument so that you can view the levels close to your invested price |
| W | Check this box to view only weekly levels. |
| M | Check this box to view only monthly levels. |
| Q | Check this box to view only quarterly levels. |
| Y | Check this box to view only yearly levels. |
| W2, W3 . . . R/S | 2nd Week High/Low on “date”, 3rd Week High/Low on “date”, . . . |
| M1, M2 . . . R/S | 2nd Week High/Low on “date”, 3rd Week High/Low on “date”, . . . |
| Q1, Q2 . . . R/S | 1st Quarter High/Low on “date”, 2nd Quarter High/Low on “date”, . . . |
| Y1, Y2, . . . R/S | 1st Year High/Low on “date”, 2nd Year High/Low on “date”, . . . |

Underneath the checkboxes, there would be a static display of the values corresponding to IDH, IDL, LTP, ADM and AWM, when the instrument is chosen. IDH, IDL and LTP values can be updated by clicking on the Refresh Button in the Ladder.

IDH—denotes Intra Day High. This displays the highest price at which the chosen security has traded on the current day
IDL—denotes Intra Day Low. This displays the lowest price at which the chosen security has traded on the current day
LTP—denotes Last Traded Price. This displays the latest price at which the chosen security has traded on the current day
ADM—denotes Average Daily Movement. The ADM is calculated by adding together the absolute values of the difference between daily high and low of every trading day and dividing the sum by the number of days in which the security was traded in the last one year period.
AWM—denotes Average Weekly Movement. The AWM is calculated by adding together the absolute values of the difference between weekly high and low of every trading week and dividing the sum by the number of weeks in which the security was traded in the last one year period.

Clicking the “Show” button processes the request and executes a run-time command on the database servers and displays the levels according to the user's chosen input parameters.

### Correlation Ladder Matrix

1. It is envisaged to show correlated markets in groups as per manner below:

### Commodities: GOLD, COMEX; SILVER, COMEXCRUDE OIL, NYMEX; HEATING OIL, NYMEX; GASOLINE, NYMEX; COPPER, COMEX; COPPER, LME; LEAD, LME; ZINC, LME; ALUMINIUM, LME; NICKEL, LME

### Indices: S&P CNX NIFTY FUT, NSE; MINI DOW FUT, CBOT; S&P 500 MINI FUT, CME; FTSE 100 FUT, NYSE LIFFE; EURO STOXX 50 FUT, EUREX; CAC 40 FUT, NYSE LIFFE; DAX FUT, EUREX

### Stocks: Top 10 Stocks of NSE

### Currencies: EURUSD FUT, CME; GBPUSD FUT, CME; USDJPY FUT, CME; USDINR FUT, MCX-SX

### Bonds: EURO BUND FUT, EUREX; US 10YR NOTE FUT, CBOT

These groups contain some of the selected instruments only and are not exhaustive.

It is envisaged to create a tab in the matrix which would allow users to add instruments of their own choice into the Correlation Ladder Matrix.

2. Live Quotes and EOD data in the ladder format.

Live quotes are placed at the centre and highlighted with a different colour, preferably yellow.

The Correlation Ladder Matrix contains the same data as the Individual ladders given in the website.

3. Above the LTP are values of—IDH, PDH, D2H, D3H, D4H

Above these daily levels, the nearest 4 weekly levels would appear in ascending order. For example, it would show W1, W2, W16, W32.

Below the LTP are values of—IDL, PDL, D2L, D3L, D4L
Below these daily levels, the nearest 4 weekly levels would appear in descending order. For example, it would show W1, W2, W16, W32.
4. In High Prices, a Red colour band signifies that the LTP has crossed that High price at least once intraday. In Low Prices, a Blue colour band signifies that the LTP has crossed the low price at least once intraday.

The levels displayed in this ladder matrix would be similar to the price levels generated by checking the “dynamiclevels” box and sort by “date” option in a ladder of the Levels webpage.

The Correlation Ladder Matrix includes a False/Right Breakout Indicator for both high and low sides of the market. This is achieved by the following logic:

For High Prices:

If LTP is greater than any level in the matrix on the higher side, then that particular level would signify a right breakout level. This would accordingly be denoted as “level+HB”. For example, W1HB, D4HB, D2HB and so on.

Again, if IDH is greater than any level in the matrix on the higher side but the LTP is below it, then that would be denoted as “level+HF”. For example W1HF, D4HF, D2HF and so on.

In both the above cases, priority will be given to higher values.

For Low Prices:

If LTP is lower than any level in the matrix on the lower side, then that particular level would signify a right breakout level. This would accordingly be denoted as “level+LB”. For example, W1LB, D4LB, D2LB and so on.

Again, if IDL is lower than any level in the matrix on the lower side but the LTP is above it, then that would be denoted as “level+LF”. For example W1LF, D4LF, D2LF and so on.

In both the above cases, priority will be given to lower values.

All these indicators will be reversed (say W1HB to *W1LB, D4LF to *D4HF) if the instrument has an inverse relation with the world indices.

Preferably, Indicators of the higher sides (HFs and HBs) would be shown in the High Row of the False/Right Breakout section.

Similarly, Indicators of the lower sides (LFs and LBs) would be shown in the Low Row of the False/Right Breakout section.

The summary section would simply show the count of all the right and false breakouts for both high and low scenarios.

### Explanation of W, M, Q, Y

The date of the current day is considered as the reference date and all the time periods are calculated in relation to the reference date.

The weekly levels are calculated in the following manner:

Scenario 1 (for exchanges that operate from Monday to Saturday):

The last completed calendar week starting from Monday and ending on Saturday, prior to the reference date, is considered as week one and abbreviated as “W1”. The calendar week (i.e., Monday start and Saturday finish) prior to W1, is considered as week two and abbreviated as “W2”. The calendar week prior to W2, would be considered as W3 and so on.

### Example 1

If reference date is 12^{th} Aug., 2011 (Friday), then W1 will be the time range between 1^{st} Aug. 2011 (Monday) and 6^{th} Aug., 2011 (Saturday). W2 would be the time range between 25^{th} Jul., 2011 (Monday) and 30^{th} Jul., 2011 (Saturday).

### Example 2

If the reference date is 7^{th} Apr., 2011 (Thursday), then W1 will be the time range between 28 Mar. 2011 (Monday) and 2^{nd} Apr., 2011 (Saturday). W2 would be the time range between 21^{st} Mar., 2011 (Monday) and 26^{th} Mar., 2011 (Saturday).

Scenario 2 (For Exchanges that Operate from Monday to Friday):

The last completed calendar week starting from Monday and ending on Friday, prior to the reference date, is considered as week one and abbreviated as “W1”. The calendar week (i.e., Monday start and Friday finish) prior to W1, is considered as week two and abbreviated as “W2”. The calendar week prior to W2, would be considered as W3 and so on.

### Example 1

If reference date is 12^{th} Aug., 2011 (Friday), then W1 will be the time range between 1^{st} Aug. 2011 (Monday) and 5th Aug., 2011 (Friday). W2 would be the time range between 25^{th} Jul., 2011 (Monday) and 29^{th} Jul., 2011 (Friday).

### Example 2

If the reference date is 7^{th} Apr., 2011 (Thursday), then W1 will be the time range between 28 Mar. 2011 (Monday) and 1st Apr., 2011 (Friday). W2 would be the time range between 21^{st} Mar., 2011 (Monday) and 25th Mar., 2011 (Friday).

If incidentally, W1 is the lowest price level of last ‘n’ number of weeks' low, then the row would display W′n′ instead of W1 in the period column. For example, if W1 is the lowest price level for the last 6 weeks, then the row would show W6 instead of W1 in the period column.

Similarly, if W1 is the highest price level of last ‘n’ number of weeks' high, then the row would display W‘n’ instead of W1 in the period column. For example, if W1 is the highest price level for the last 6 weeks, then the row would show W6 instead of W1 in the period column.

The monthly levels are calculated in the following manner:

The last completed calendar month prior to the reference date, is considered as month one and abbreviated as “M1”. The calendar month prior to M1, is considered as month two and abbreviated as “M2”. The calendar month prior to M2, would be considered as M3 and so on.

### Example

If reference date is 12^{th} Aug., 2011 then M1 will be the time range between 1^{st} Jul. 2011 and 31^{st} Jul., 2011. M2 would be the time range between 1^{st} Jun., 2011 and 30^{th} Jun., 2011.

The Quarterly levels are calculated in the following manner:

The last completed calendar quarter prior to the reference date, is considered as quarter one and abbreviated as “Q1”. The calendar quarter prior to Q1, is considered as quarter two and abbreviated as “Q2”. The calendar quarter prior to Q2, would be considered as Q3 and so on.

### Example

If reference date is 12^{th} Aug., 2011 then Q1 will be the time range between 1^{st} Apr. 2011 and 30^{th} Jun., 2011. Q2 would be the time range between 1^{st} Jan., 2011 and 31^{st} Mar., 2011.

The Yearly levels are calculated in the following manner:

The last completed calendar year prior to the reference date, is considered as year one and abbreviated as “Y1”. The calendar year prior to Y1, is considered as year two and abbreviated as “Y2”. The calendar year prior to Y2, would be considered as Y3 and so on.

### Example

If reference date is 12^{th} Aug., 2011 then Y1 will be the time range between 1^{st} Jan. 2010 and 31^{st} Dec., 2010. Y2 would be the time range between 1^{st} Jan., 2009 and 31^{st} Dec., 2009.

### Display Mechanism of Levels

The first column of the ladder is “Price” which would numerically display the price levels. Against “Price”, abbreviations including but not limited to “(INR)”, “(USD)”, “(EUR)”, “(JPY)”, “(GBP)”, “(CNY)”, “(HKD)”, “(CHF)”, “(BRL)”, “(AUD)”, “(KRW)”, “(CAD)” would automatically appear denoting the currency in which the queried instrument is traded.

The second column of the ladder is “Period” and would display the time period which the price corresponds to. Abbreviations like W1 or Q9 would imply week one and quarter nine respectively.

The third column of the ladder “S/R” would show the letter “R” against each price level above the queried price and “S” against each price level below the queried “My Price”. “R” stands for resistance and “S” stands for Support.

The fourth column of the ladder “T” would be used to display “BO” (Breakout) levels

Typically, the first row above and below the user's price, would display the previous day high and low respectively. Previous day high would be abbreviated as “PDH” and previous day low would be abbreviated as “PDL”. The rows showing PDH and PDL would always be highlighted and would not have the R or S mentioned as this is for the user's information only. The rows displaying PDH and PDL would be highlighted.

Additionally, the immediately prior calendar week's high and low, above and below the user's price respectively, would always be displayed. This would be abbreviated as “W1” in the period column.

Daily levels (D2, D6, D8, D12, etc) for last 3 weeks including the current week would be displayed in the ladder only if the “Dynamiclevels” checkbox is selected.

The rows displaying price levels “W1”, “PDH/PDL” and “D 2/3/4” would be automatically arranged in ascending order above the user's price and descending order below the user's price.

By default, the highest of W1, W2, W3 and W4 levels would have “MR” (Major Resistance) shown in the R/S column and also display “BO” (Breakout) in the fourth column (“T”) of the ladder.

By default, the lowest of W1, W2, W3 and W4 levels would have “MS” (Major Support) shown in the R/S column and also display “BO” (Breakout) in the fourth column (“T”) of the ladder.

The ladder will show “BO” in column “T” wherever there is “MR/MS” in the R/S column and vice versa.

If the difference between any two subsequent price levels equals or exceeds two times the value of ADM, the row containing the lower price level would display MR in the third column and BO in the fourth column. This is for rows above the user's price. Similarly, if the difference between any two subsequent price levels equals or exceeds two times the value of ADM, the row containing the higher price level would display MS in the third column and BO in the fourth column, this being for rows below the user's price. The row displaying BO in the fourth column would be made bold.

If any day's high is incidentally the highest price for more than one time period, then those time periods would be combined together and shown in a single row and the date of that particular day is shown as a tool tip. Similarly, if any day's low is incidentally the lowest price for more than one time period, then those time periods would be combined together and shown in a single row and the date of that particular day is shown as a tool tip.

Every ladder would have a button on its top right corner which would allow the user to save the search criteria of the associated box in the user's “Favourite” list. A tool-tip mentioning “Add to Favourites” would appear by hovering the pointer of a pointing device over it and would disappear automatically with the next change in position of the pointer.

Clicking on the icon below the favourites button would open up a prompt to enter another user's email address and the button to submit. Once submitted, an email would be sent to that email id having the link of search criteria generated in the ladder. Once the recipient gets the email, he would have to login into the solution or signup. Upon successful login/signup by the recipient can click on the embedded link to see the Levels. Information of the shared data would be logged into the database for reporting and monitoring purpose. A tool-tip mentioning

“Share with Friends” would appear by hovering the pointer of a pointing device over it and would disappear automatically with the next change in position of the pointer.

Clicking on the button below would allow the user to zoom in on a particular ladder and make it look clearly distinguished from other ladders. A tool-tip mentioning “Enlarge” would appear by hovering the pointer of a pointing device over it and would disappear automatically with the next change in position of the pointer. (FIG. 11).

The hardware necessary to implement the solution is illustrated and explained as below (FIG. 12).

This invention is developed using following Technical Stack (LAMP)
LINUX Operating System—CentOS 5.4 or Red Hat Linux
APACHE Web Server—2.2.3
MySQL Database—Enterprise Edition
PHP Programming Language—5.3.2
HTML Markup Language
CodeIgniter Open Source PHP Web Application Framework

The invention resides in gathering of historical market data and developing a program which updates the data on a daily basis. The search option in the ladder has been optimized to quickly display the name of the instrument so that the data related to that instrument can be displayed faster. The application is programmed to capture the data from the data provider automatically and systematically insert this data into our database. Another inventive software displays the data in a ladder format to the user.

Multi-media processing is not involved. The historical financial data is acquired from various sources in text format and stored in a secure database server. Further, market data and information stored in these servers may include but not be limited to XML documents, flat files, comma-separated value (CSV) files, SQL tables, relational database tables and any other format operable to store data.

Users have an option of saving the search criteria in his/her favourite list (i.e. accessible only from his/her account). They can also copy-paste data from the browser on computer screen or can take a print-screen from their keyboards and save it for later use.

The invention can provide display up to eight ladders at a time on a single computer/laptop screen (FIG. 13).

By scrolling down, the user can clearly see four more ladders (FIG. 14).

There is no limitation on the traded commodities, stocks, bonds, currencies, data whereof can be accessed. The user can access any data of commodities, stocks, bonds and currencies. However, in one single computer display, he can view up to a maximum of eight ladders. The user has the option to add/delete instruments within the said limitation of eight ladders.

All the data made available on the mobile device or computer screen is filterable. There are four filtering options for the user as explained below.

### (1) Global Instrument Search Field

In each ladder, the first field is the global instruments search box in which the user inputs the name of the instrument for which he seeks to know the price levels. The user must input at least three characters of the instrument's name to automatically invoke suggestions via a drop down menu. The menu so invoked would show lesser and lesser suggestions as the user types more and more characters of his instrument's name.

(2) Price field

Below the global instrument search box, on the left, would be a field in which the user inputs a price for his security of interest. Only numerical characters are allowed for entry into this field. For querying currency instruments, the user can specify numerical values having up to four decimal points and two decimals for any other class of instruments. By default, the previous day's closing price for the instrument selected would be shown in the price field. By hovering over this field using a pointing peripheral, a tool tip would be displayed saying “Enter your price, by default it shows the close price of the last trading day. You also have an option of putting your price for the chosen instrument so that you can view the levels close to your invested price” (FIG. 15)

### (3) Time Period

Below the Price section, there would be four check-boxes “W”, “M”, “Q” and “Y” in which the user places a tick on any one, all, or in combinations against the said checkboxes. “W” corresponds to weekly price levels, “M” corresponds to monthly price levels, “Q” corresponds to quarterly price levels, “Y” corresponds to yearly price levels and “Dynamiclevels” corresponds to levels as per the in-house research knowledge. By default, all check-boxes would be tick marked (FIG. 16).

### (4) Sort By

Below the Price section, the user can use the “Sort by” option to view results displayed in terms of “price” or “date”.

The ladder shows values greater than the specified price in an ascending order above the user's price. Conversely, the ladder shows values lower than the specified price in a descending order below the user's price. This arrangement, both for rows above and below the user's price is arranged chronologically, only if the user selects to sort the ladder by “date”. When the Dynamiclevels checkbox is unchecked and the ladder is sort by “price”, the ladder will show only those levels corresponding to checkboxes marked against W, M, Q, Y (which may be marked individually or in combinations thereof).

User screen for devices having touch-screen are optimized for those devices having various screen technologies. Industry best practices and techniques to enhance user experience have been followed in creating innovative and intuitive navigational scheme. The user would be able to carry out all required functions using touch screen and/or using the provided keypad, if any.

The structure of the server system is described below with reference to FIG. 4. Each component of the server system is detailed below:
a. Load Balancer
   i. This is a physical server or machine hosted remotely, which runs a code having algorithm to distribute load of incoming requests to two or more Application Servers connected in parallel.
   ii. This is standard code supplied by third parties
   iii. The various configurable algorithms used for load balancing could be—Random, Round Robin, Weighted Round Robin, Least Connections, and Weighted Least Connections etc
b. Application Server(s)
   i. These are servers or machines running Web Server (that is serving Web Content to browsers) and the Application Code (Views and Business Logic)
   ii. Application servers would run in parallel, incoming requests would be assigned to one of the Application Servers by Load Balancer based on given load balancing algorithm.
c. Database Server(s)
   i. These servers host the data (backend) of the application
   ii. Data is extracted from various external sources by way of defined routines firing at pre-defined intervals and inserted in the database
   iii. Database also logs all the user actions e.g. User subscription information, various logs, portfolios, etc.

The function and purpose of the load balancers and the software and/or hardware used for load balancing is explained below. In a preferred embodiment, Rackspace Managed Hosting Solution can be used. The following is hardware and software stack:

### Hosting Environment—Cloud Based

### Processor—Intel QUAD CORE 3 GHz

### RAM—16 GB DDRII RAM

### Operating System—Red Had Linux

### Web Server—Apache

### Database—MySQL Enterprise Edition

### Programming Language—PHP

The historical market data can be collected from multiple sources, e.g., Bloomberg, Reuters, e-signal, etc.

Process flow and table structure of database construction:

### Database Table Structure:

The database contains the following tables:

TABLE
api_daily_data

| Field | Type | Field Description |
|---|---|---|
| Dly_Security | varchar(120) | Security Name |
| Dly_Date | varchar(45) | Date |
| Dly_High | varchar(45) | Highest Price of the Security of that |
| | | Date. |
| Dly_Low | varchar(45) | Lowest Price of the Security of that |
| | | Date. |
| Dly_Last_Upd | varchar(25) | Date and Time of the downloaded |
| | | data. |
| Dly_Close | varchar(45) | Close Price of the Security of that |
| | | Date. |
| Dly_Open | varchar(45) | Open Price of the Security of that |
| | | Date. |
| Dly_Response_Id | varchar(150) | Response Id as returned by |
| | | Bloomberg. |

TABLE
daily_data

| Field | Type | Field Description |
|---|---|---|
| dly_Security | varchar(132) | Security Name |
| dly_Date | datetime | Date |
| dly_High | decimal(20,6) | Highest Price of the Security of that Date. |
| dly_Low | decimal(20,6) | Lowest Price of the Security of that Date. |
| dly_Close | decimal(20,6) | Close Price of the Security of that Date. |
| dly_Open | decimal(20,6) | Open Price of the Security of that Date. |

TABLE
daily_data_exception

| Field | Type | Field Description |
|---|---|---|
| exp_Security | varchar(120) | Wrong/Duplicate Security Name |
| exp_Date | varchar(50) | Date |
| exp_High | varchar(50) | Highest Price of the Wrong/Duplicate |
| | | Security of that Date. |
| exp_Low | varchar(50) | Lowest Price of the Wrong/Duplicate |
| | | Security of that Date. |
| exp_Close | varchar(50) | Close Price of the Wrong/Duplicate |
| | | Security of that Date. |
| exp_Open | varchar(50) | Open Price of the Wrong/Duplicate |
| | | Security of that Date. |
| exp_Response_Id | varchar(150) | Response Id of the Wrong/Duplicate |
| | | Data. |
| exp_Lst_Updt | varchar(100) | DateTime of Wrong/Duplicate Data. |
| exp_Type | varchar(150) | Incomplete Data: If Comes with |
| | | N.A./Blank |
| | | Duplicate Data: if Data already |
| | | exists in daily data Table. |

TABLE
global_parameter

| Field | Type | Field Description |
|---|---|---|
| Parameter | varchar(100) | Name of Parameter |
| Param_Value | varchar(100) | Value of Parameter |

TABLE
modify_daily_data

| Field | Type | Field Description |
|---|---|---|
| mod_Security | varchar(132) | Backup Security Name |
| mod_Date | datetime | Backup Date |
| mod_High | decimal(20,6) | Highest Price of the Backup |
| | | Security of that Date. |
| mod_Low | decimal(20,6) | Lowest Price of the Backup |
| | | Security of that Date. |
| mod_Close | decimal(20,6) | Close Price of the Backup |
| | | Security of that Date. |
| mod_Open | decimal(20,6) | Open Price of the Backup |
| | | Security of that Date. |
| mod_id | int(11) | Batch Id |
| mod_User | varchar(132) | User Name. |
| mod_Entry_Date | datetime | Date and Time of the process. |

TABLE
symbol_master

| Field | Type | Comment |
|---|---|---|
| Symbol_Id | int(10) | Auto Increment Id |
| Symbol_Name | varchar(100) | Bloomberg Symbol of the Security |
| Remarks | varchar(150) | Remarks |
| Active | char(1) | Y = Active, N = Inactive |
| DISPLAY | varchar(300) | Combination of INSTRUMENT_1 + |
| | | EXCHANGE_1 + COUNTRY_1 + SEGMENT |
| INSTRUMENT_1 | varchar(200) | Full Name of the Security |
| EXCHANGE_1 | varchar(100) | Exchange of the Security. |
| COUNTRY_1 | varchar(100) | Country of the Security. |
| CONTINENT | varchar(100) | Continent of the Security. |
| SEGMENT | varchar(45) | Segment of the Security. |
| INSTRUMENT_2 | varchar(300) | Alternative Name of the Security. |
| INSTRUMENT_3 | varchar(300) | Any other Name the Security is known. |
| EXCHANGE_2 | varchar(45) | Alternative Exchange of the Security. |
| EXCHANGE_3 | varchar(45) | Any other Name the Exchange is known. |
| COUNTRY_2 | varchar(45) | Alternative Country of the Security. |
| COUNTRY_3 | varchar(45) | Any other Country of the Security. |
| DEC_POINTS | int(10) | Represent the no. digits to show after the |
| | | decimal point. |
| CURRENCY | varchar(50) | Currency name of the security. |
| DWNLD_DATA | char(1) | Y = Download Data, N = Do not Download |
| | | Data |
| UPDT_TIME | timestamp | Update time of the record. |

TABLE
symbol_master_exception

| Field | Type | Field Description |
|---|---|---|
| sme_Security | varchar(100) | Security Name those traded on Saturday |
| | | also |
| dwnld_data | varchar(1) | Y = Download Data, N = Do not |
| | | Download Data |

TABLE
Temp_daily_data

| Field | Type | Field Description |
|---|---|---|
| dly_Security | varchar(132) | Security Name |
| dly_Date | datetime | Date |
| dly_High | decimal(20,6) | Highest Price of the Security of |
| | | that Date. |
| dly_Low | decimal(20,6) | Lowest Price of the Security of that |
| | | Date. |
| dly_Close | decimal(20,6) | Close Price of the Security of that |
| | | Date. |
| dly_Open | decimal(20,6) | Open Price of the Security of that |
| | | Date. |
| dly_Response_Id | varchar(150) | Response Id as returned by |
| | | Bloomberg. |
| Dly_Last_Upd | varchar(25)\grave{ } | Data and Time. |

TABLE
Temp_symbol_master

| Field | Type | Field Description |
|---|---|---|
| Symbol_Id | int(10) | Auto Increment Id |
| Symbol_Name | varchar(100) | Bloomberg Symbol of the Security |
| Remarks | varchar(150) | Remarks |
| Active | char(1) | Y = Active, N = Inactive |
| DISPLAY | varchar(300) | Combination of INSTRUMENT_1 + |
| | | EXCHANGE_1 + COUNTRY_1 + SEGMENT |
| INSTRUMENT_1 | varchar(200) | Full Name of the Security |
| EXCHANGE_1 | varchar(100) | This Security belongs to this Exchange. |
| COUNTRY_1 | varchar(100) | This Security belongs to this Country. |
| CONTINENT | varchar(100) | This Security belongs to this Continent. |
| SEGMENT | varchar(45) | This Security belongs to this Segment. |
| INSTRUMENT_2 | varchar(300) | Alternative Name of the Security. |
| INSTRUMENT_3 | varchar(300) | Any Other Name of the Security. |
| EXCHANGE_2 | varchar(45) | Alternative Exchange of the Security. |
| EXCHANGE_3 | varchar(45) | Any Other Exchange of the Security. |
| COUNTRY_2 | varchar(45) | Alternative Country of the Security. |
| COUNTRY_3 | varchar(45) | Any Other Country of the Security. |
| DEC_POINTS | int(10) | Represent the no of Decimal. |
| CURRENCY | varchar(50) | Currency name of the security. |
| DWNLD_DATA | char(1) | Y = Download Data, N = Do not Download |
| | | Data |
| UPDT_TIME | timestamp | Update time of the record. |

### Process Flow:

01. ‘daily_data’ is the main storage table from where the ‘Ladder Report’ fetches the data. This table stores data of the Securities listed in the ‘symbol_master’ table within a date range of 1^{st} Jan., 1996—till date. This table is updated daily.
02. Data downloaded from Bloomberg/Other data sources is first stored in ‘api_daily_data’ table. Once the data is downloaded they are transferred to ‘daily_data’ table after validating duplicate and incomplete records. Once downloading is complete, all the data are copied in the ‘Temp_daily_data’ to keep a back up of downloaded data. After that, all the correct data are inserted in ‘daily_data’ table and the duplicate and incomplete entries are inserted in ‘daily_data_exception’ table with ‘Duplicate Data’ and ‘Incomplete Data’ tag respectively. The ‘api_daily_data’ table is truncated before every instance of data download from Bloomberg/Other data sources.
03. Whenever there is any need to modify/delete any records from the ‘daily_data’ table, it is first copied in to ‘modify_daily_data’ table with its original values for future reference.
04. ‘symbol_master_exception’ contains a list of securities which requires different fields to be called while downloading daily data from ‘Bloomberg’.
05. ‘global_parameter’ table contains the value which signifies the maximum number of levels to be calculated while displaying the ladder. This table has the scope to contain data for various other purposes as and when needed.

### Display Ladder Process:

### Required Input Parameters:

| Parameter | | |
|---|---|---|
| Name | Datatype | Description |
| per_type | VARCHAR(20) | Period Type i.e. Weekly or Monthly or |
| | | Quarterly or Yearly or a |
| | | combination of these |
| sec_name | VARCHAR(250) | Security Name |
| my_price | DECIMAL(20,4) | Base Price depending upon which the |
| | | resistances and supports |
| | | are to be calculated |
| display_type | CHAR(1) | Order of sorting the ladder, ‘D’ For |
| | | Date wise + Price wise, ‘P’ for |
| | | only Price wise. |
| ref_date | DATETIME | Base date regarding which the Periods |
| | | are calculated; default Current Date |

### Steps:

1. As per user's chosen security, dly_date, dly_high and dly_low information of that security is gathered from the daily_data table into a temporary table ‘daily_data_a’.
2. From the daily_data_a table, data is then processed to find out the ‘Week No’ (in respect to the ‘ref_date’) of each and every date and the highest value and the lowest value of each Week including the date on which the highest/lowest price was reached and the Week No. itself if fetched and inserted in to another temporary table called temp_data. This process is only done if the user has opted to see the ‘weekly levels’ by ‘Checking’ the ‘W’ option from the front end.
3. The same process is replicated to find out the highest/lowest values and their dates of each Daily, Monthly, Quarterly and Yearly period ranges.
4. From temp_data table, a process is being run to combine the weekly/monthly/quarterly/yearly/daily period ranges of the same date into one single level and is inserted into another temporary table ‘processed_data’. All the ‘High’ values of different period ranges are tagged as ‘R’ and ‘Low’ values are tagged as ‘S’.
5. Multiple variables are then calculated to prepare the final report, these are
   Sym_ADM: Average Daily Movement for the last 3 years
   PD_High: Last Trading Day High
   PD_Low: Last Trading Day Low
   PD_dt: Date of Last Trading Day
   R_High: Highest of Last Four Week Highs.
   R_Low: Lowest of Last Four Week Lows.
   M1_High: High or M1′.
   M1_Low: Low of ‘M1’.
   M1_High_Date: Date of M1_High.
   M1_Low_Date: Date of M1_Low.
   Dec_Pts: Number of digits to show after decimal point for that Security, derived from ‘symbol_master’
   W1_High: High of ‘W1’
   W1_High_date: Date of W1_High
   W2_High_date: Date of W2_High
   W1_Low: Low of ‘W1’
   W1_Low_date: Date of W1_Low
   W2_Low_date: Date of W2_Low
6. These variables are being compared and the final report (as per the front end display) is being prepared. All the ‘R’ values are shown above ‘my_price’ and all the ‘S’ values are shown below ‘my_price’. If any two levels have absolute difference of more than 3 times of that symbols ADM, then the one nearest to ‘my_price’ is tagged as ‘BO’. The levels matching ‘R_High’/‘R_Low’ values are tagged as ‘BO’ by default. All the corresponding ‘R’ and ‘S’ are shown as ‘MR’/‘MS’ if they are tagged as ‘BO’.

### Search Engine Explanation:

The symbol search autocomplete appears as the user inputs more than 2 characters in the search box. The same process is called each time the user adds more characters (including ‘Space’) in the search box and autocomplete results are further filtered depending upon his input.

### Steps:

1. The following fields in the Symbol_master table are combined and is denoted as ‘Combo’—Symbol_Name, INSTRUMENT_{—}1, EXCHANGE_{—}1, COUNTRY_{—}1, CONTINENT, SEGMENT,
   INSTRUMENT_{—}2, INSTRUMENT_{—}3, EXCHANGE_{—}2, EXCHANGE_{—}3, COUNTRY_{—}2, COUNTRY_{—}3.
2. The input of the user in the search box is split in to four text strings namely str_{—}1, str_{—}2, str_{—}3 and str_{—}4. The split is done by the ‘Spaces’ in the input string. The first three parts of the input string separated by ‘Space’ are called as str_{—}1, str_{—}2 and str_{—}3 respective. The rest of the input string is called str_{—}4 (which may include ‘Space’). In case there are not enough ‘Spaces’ in the input string to split it in two parts or more, then str_{—}2/str_{—}3/str_{—}4 are left ‘Blank’.
Example
   a. If the user puts ‘Copper MCX India Asia’ in the search box then the ‘str_’ variables will be assigned the following values: str_{—}1=India, str_{—}2=MCX, str_{—}3=India and str_{—}4=Asia.
   b. If the user puts ‘Copper MCX India’ in the search box then the ‘str_’ variables will be assigned the following values: str_{—}1=India, str_{—}2=MCX, str_{—}3=India and str_{—}4=‘ ’ (Blank).
   c. If the user puts ‘Copper MCX’ in the search box then the ‘str_’ variables will be assigned the following values assigned to: str_{—}1=India, str_{—}2=MCX, str_{—}3=‘(Blank) and str_{—}4=’ (Blank).
   d. If the user puts only ‘Copper in the search box then the ‘str_’ variables will be assigned the following values: str_{—}1=India, str_=‘ ’(Blank), str_{—}3=’ (Blank) and str_{—}4=‘ ’(Blank).
   e. If the user puts ‘Copper MCX India Asia Commodity’ in the search box then the ‘str_’ variables will be assigned the following values: str_{—}1=India, str_{—}2=MCX, str_{—}3=India and str_{—}4=Asia Commodity.
3. After assigning the ‘str_’ values, the process then filters the symbol_master database and searches for symbols where ‘Combo’ contains all the ‘str_’ strings in it. The filtered symbols are then shown in the autocomplete.

Please refer to FIGS. 17 to 19.

The code and work-flow how the display of historical data is achieved on a mobile device is now explained in detail with illustrative diagrams.

For Apple (FIG. 20)—
1. Prepared User Interface for the target device(s)
2. Used iPhone 4 Apple Development SDK tool Xcode to develop application integrating the User views with the standard API calls to Webserver hosting the Web Application
3. The Web application implements the business logic and connection to database
4. Compiled the application for iPhone OS 4 using Xcode and test on the provided simulator and real device
5. Published the final version of App on App Store by submitting to App Developer Program, signed using own Apple Developer Certificate.

### For Android (FIG. 21)—

1. Prepared User Interface for the target device(s)
2. Used Android 3.2 Development SDK and Eclipse IDE to develop application integrating the User views with the standard API calls to Webserver hosting the Web Application
3. The Web application implements the business logic and connection to database
4. Run and tested on the provided simulator and real device
5. Published the final version of App Android Market.

### For Blackberry (FIGS. 35)—

1. Prepared User Interface for the target device(s) and get it signed off by customer
2. Used J2ME Development SDK to develop application integrating the User views with the standard API calls to Webserver hosting the Web Application
3. The Web application implements the business logic and connection to database
4. Run and tested on the provided simulator and real device
5. Published the final version of Blackberry App World.
   The code and work-flow how the user accesses the display is explained in detail with illustrative diagrams.
   For a computer/laptop device—

The first entry into the interface would initiate a login page where the solution requires a mandatory registration and entry of the user's valid email account and password. The user will be able to access the solution by visiting a pre-defined URL in his/her internet browser.

The user can go to the home page of the solution by clicking on ‘home’ or the logo of the solution.

By scrolling down the home page, the user can see various ladders displaying key price levels for global indices, global currencies, precious metals, base metals, bonds, energy, etc. For these ladders, it is envisaged to consider eight price levels, high and low of D2, D3, D4 and W1, whichever is closest to either the previous day close price or the delayed last traded price.

The level

(a) having the least absolute difference with the previous day close and

(b) having the difference within 20% of the symbol's ADM would be displayed as W1 or “D 2/3/4” H/L (as the case may be), else no level would be shown for the relevant security. It may be envisaged to calculate the absolute difference from delayed market data instead of previous day close.

It is also envisaged that a National Stock Exchange, India (NSE) sectoral ladder would be displayed on the home page and clicking this ladder would open a new webpage and this would display the contents for the selected sector. Additionally, a user can select sectors from a drop down list and choose different sectors of the NSE.

The user can log into the solution by entering his valid e-mail address in full and password at the top of the website and clicking on Login.

The user can also login to the solution if he already has a valid Facebook or Gmail account

In case the user forgets his password, he can click on ‘forgot password’ and the system would send a temporary password to the user's email address with which he signs into the solution.

Every successful login by the user would record and log the IP Address of the user, name of browser involved, device from where the login was made, the country from where the user logged in along with the date and time of login.

Preferably a caution to investing in securities would forewarn the user and communicate the market risks associated. This would appear in the interface after the successful log in by the said user. The user necessarily will have to accept the undertaking that he has read and understood clearly, fully and completely the matter contained therein.

After successful login by the user, the solution would log out the session automatically after twelve hours starting from the time of such login.

The solution would allow only one instance of the user's session to be active and would grant access to it only once from one location and one platform.

By default, the language would be English.

The user can register to the solution by clicking on the “Sign Up” button and entering information as required and mentioned in the fields on the middle right section of the home page of the website.

The first field would require the user to enter his/her first name

The second field would require the user to enter his/her surname.

The third field would require the user to enter his/her valid e-mail address

The fourth field would require the user to input a desired password. The said password should be of minimum six characters

The fifth field would require the user to re-enter the password which he/she entered in the fourth field

The birthday section would require the user to select the year, date and month of his birth from the list of available entries in the drop-down menus in each of the fields of year, date and month. The user would necessarily have to be 18 years and above to successfully register and use the solution.

The user would be made to enter the verification code generated by a captcha graphic when all fields are completely and suitably input. If the matter contained in the graphic is not suitably legible, the user can change the graphic by clicking on “Click to change” beneath the graphic.

The user would have to place a tick mark against “I agree to terms and conditions” and on which the user can click to view the solution's legal notice.

Upon clicking on the Sign Up button, the user is directed to a webpage that shows the Legal Notice comprising of the Disclaimer, Privacy Policy and Terms of Service of the inventive solution. The content would be static in nature and the user must place a tick mark in the box adjacent to the caption ‘I agree’ to complete the registration process.

The user would be sent an activation link at his email address and upon clicking this link; the user's account would become active.

The user can click on “Trouble Logging In?” which would open a window using which the user can gain access to the chat functionality of the solution and this would facilitate prompt remedies for his queries.

Icons of third party entities like Facebook, Twitter, Linked In would appear in the bottom right hand corner of the homepage. Upon clicking these, the user would be directed to the profile page of the solution maintained with each of these third party entities.

The left portion in the middle of the homepage would host an animation of various platforms which include but may not be limited to Iphone, Blackberry, Android, on which the service can be accessed and used. The user can pause the screen transition at any time by clicking on the small dot corresponding to the said screen. Upon clicking anywhere on a particular screen for a particular platform, the user would get directed to a page where the compatible devices and download details for the said platform would be displayed.

Located at the footer of the homepage would be “Help” which upon clicking would display static content of information of a typical ladder and this would facilitate better understanding for effectively using the ladder. The user can also view a correlation table which would numerically display the degree of correlation between instruments belonging to global indices, currencies, bonds, base metals, energy commodities and precious metals. (FIGS. 23 and 24)

FIGS. 25, 26, and 27 display the correlation ladder matrix for indices, commodities, and currencies with viewing tabs.

FIGS. 28, 29, and 30 give the full view of correlation ladder matrix for indices, commodities, and currencies on selection of respective tabs.

The code and work-flow of the scrolling mechanism on the ladder is explained in detail with illustrative diagrams (FIG. 32). Preferably the ladder would comprise of a vertical scrolling mechanism. The ladder will typically show a maximum of 11 rows (1 row for ‘Price’+5 rows for Resistance Levels+5 Rows for Support Levels) in case of Desktop/Laptop systems, and 9 rows in case of Mobile Devices, at a time. If and when the user wishes to see more levels than the default ones (5 for desktop/laptop and 4 for Mobile devices), he can use the vertical scroll bar. The function to scroll the ladder would enable the user to access a longer list of entries on limited-sized display screens. As a result of including such a scrolling mechanism, any amount of data and information may be accessed and viewed on a single interactive interface, regardless of the size of the display area.

There is no specific coding or programming done to prevent end user from copying or taking screen shots from the user screen. However, following measures are taken to protect copying from the database:
Access protected with a strong password, changeable after a predefined time
Database hosted in a secure environment, protected with software and hardware firewalls
Antivirus to prevent any malicious code, virus and Trojan attacks
128 Bit SSL compression for data exchange between User and Server
Database Server access blocked for all IPs except few designated IPs
Constant monitoring of the server through automated tools to alert in case of any suspicious activity

A tool-tip is generated when a particular price point is reached. Tooltips help give helpful insights to the end user into the various on-screen fields and values. They are like small balloons having help text which pop up when user hovers mouse over the fields or value. They are generally disposed off automatically after a certain time interval or when user moves the cursor away from fields or values (FIG. 33).

In the “Levels” webpage, underneath the logo, the user can click on “Can't find your chosen instrument?” link. This opens a Light Box which allows the user to input the name of the security he wishes to be added into the database. He can click on the cross button on the top right hand corner of the box to close it. By entering the name of the instrument and clicking on submit, the following message appears—“Thank you for your query. We will revert to you within 72 hours. We will add this Instrument if it has sufficient volume”.

The present invention has been described in terms of preferred and other embodiments. The invention, however, is not limited to the embodiments described and depicted as one familiar with the art to which the present invention pertains will readily appreciate. While particular preferred and alternative embodiments of the present intention have been disclosed, it will be appreciated that many various modifications and extensions of the above described technology may be implemented using the teaching of this invention. As the present invention may be embodied in several forms without departing from the spirit or essential characteristics thereof, it should be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method of providing worldwide historical market data of stocks, indices, commodities, currencies and bonds for a period up to 12 years in a ladder-like display of a Global Instrument Search Box (GISB) to users accessing it through a computer, mobile or other handheld devices, said method comprising steps of:
(a) choosing the financial market to which the security belongs;
(b) entering the security of interest;
(c) inputting the price for which the probable upward and/or downward price points are sought during a chosen period;
(d) checking any, ail, or any combination of the time range boxes for which historical data are sought;
(e) aggregating and filtering the information according to the search criteria inputted by the user;
(f) displaying the said aggregated/filtered data and information on user's mobile, computer, or other hand, held device showing the price, period support/resistance and breakout levels Of the instrument horizontally in a numerical format, whereby the user of the Gin receives data for high and low price of each and every security with their support, resistance and breakout levels in a time frame like ‘D’ (days), ‘W’ (weeks), ‘M’ (months) ‘Q’ (quarters) and ‘Y’ (years), individually, or in combination thereof, in one place in an user-friendly numeric format and thus helping the user in taking suitable in decisions or adopting trading strategies in respect of the security of interest.

2. The method as claimed in claim 1, wherein if the chosen number of results increases the size of the ladder, a scrolling mechanism is automatically initiated for the relevant ladder for accessing a longer lists of entries.

3. The method as claimed in claim 1, wherein the results are displayed as per the selected criteria and price by inputting a price of the security.

4. The method as claimed in claim 3, wherein the current price of the instrument can be inputted to display the next important historic price levels above and below the current market price of the instrument in the ladder.

5. The method as claimed in claim 3, wherein the price at which the instrument is bought or sold by the user can be inputted to display the next important historic price levels above and below the purchase or sale price of the instrument in the ladder.

6. The method as claimed in claim 1, wherein said time range box provides option to the user to choose from week, month, quarter and year, individually or in combination, as the time parameter for displaying the market data.

7. The method as claimed in claim 1, wherein historic highs and lows in the price of the security are generated and displayed for daily, weekly, monthly, quarterly and yearly price levels, thereby helping the investor to take decision to buy or sell a security.

8. The method as claimed in claim 7, wherein sequentially displayed historic price level of a security enables to determine suitable profit exit level for both buyers and sellers of market securities.

9. The method as claimed in claim 7, wherein two or more time frames are combined for one historical price.

10. The method as claimed in claim 1, wherein near real time feed of the last traded price, intraday high and low and historical market data are displayed in the same box.

11. The method as claimed in claim 1, wherein said GISB displays historical highs or resistances in an ascending order and historical lows or supports in a descending order.

12. The method as claimed in claim 1, wherein said GISB displays weekly, monthly, quarterly and yearly high and low price levels, support and resistance levels that assists an user with a medium or long term investment outlook to take timely decision to enter or exit the market and to buy or sell an instrument.

13. The method as claimed in claim 1, wherein said GISB displays average daily movement of the market instrument along with the near real time display of last traded price, intraday high and low that assists an user who is a day trader to take timely decision to buy or sell an instrument in an intra day trading strategy.

14. The method as claimed in claim 1, wherein said GISB displays dates on which historical highs or lows of an instrument were made in a reference period instantly at the option of the user.

15. The method as claimed in claim 1, wherein said GISB displays major resistance (MR) level of an instrument for a chosen period as the lower of the two historical highs when the difference between the two historical highs is equal to or exceeds two times the average daily movement of the instrument during the period.

16. The method as claimed in claim 14, wherein said major resistance (MR) level gives indication to an investor when the market is expected to reverse its buy momentum, which in turn signifies a profit-exit level for the investors who have brought the security.

17. The method as claimed in claim 1, wherein said GISB displays the major support (MS) level of an instrument for a chosen period as the higher of the two historical lows during the period when the difference between the two historical lows during the period is equal to or exceeds two times the average daily movement of the instrument during the period.

18. The method as claimed in claim 16, wherein said major support (MS) level gives an indication to an investor when the market is expected to reverse its sell momentum, which in turn signifies a profit-exit level for the investors who have sold the security.

19. The method as claimed in claim 1, wherein said GISB displays a high break out (HBO) level for a sudden break through of a major resistance (MR).

20. The method as claimed in claim 19, wherein RIO level is a stop loss position from a short position for an investor.

21. The method as claimed in claim 1, wherein said GISB displays a low break out (LBO) level for a sudden break through of a major support(MS).

22. The method as claimed in claim 21, wherein the LBO level is a stop loss position from a bought position for an investor.

23. The method as claimed in claim 1, wherein users has an option to view a near real time display of data for price movements of previous day closing price or last traded price across global stocks, indices, commodities, currencies and bonds vis-à-vis historical price in those markets on a single spread sheet like view of a correlation ladder matrix in a numerical format to enable the user to get a feel of the overall sentiment in the global markets.

24. The method as claimed in claim 23, wherein the price band for a market that has broken a historical high is shaded in a different color, for example red.

25. The method as claimed in claim 23, wherein the Price band for a market that has broken a historical low is shaded in a different color, for example blue.

26. The method as claimed in claim 23, wherein said correlation ladder matrix also displays live feed of intra day high (IDE) intra day low (IDL) and last traded price(LTP) of global indices, stock, currencies, commodities and bonds at the centre of the matrix in a color of different shade for example, yellow.

27. The method as claimed in claim 23, wherein the price band of a market that has broken the historic high is shaded red and price band of a market that has broken historic low is shaded blue enabling the user to judge the overall sentiment of the intra day global market by counting the red and blue spots in the matrix so that more red spots indicates that the markets have broken their historical highs and a world wide buying sentiment is in vogue with an opposite effect if there are more blue spots than red.

28. The method as claimed in claim 23, wherein at the choice of the user, the display of the matrix is restricted to an individual market in which the user has a specific interest or to a plurality of markets the user considers as important for correlation purpose.

29. A system for carrying out the method as claimed in claim 1 for displaying historical market data in a ladder-like display of a Global Instrument Search box (GISB) for stocks, indices, currencies, commodities, and bonds in a historical and numerical format to users accessing the same through a computer, a mobile or handheld device, said system comprising:
a server system having one or more computing devices in communication with one or more data source computer device(s) for receiving HTTP requests from mobile or other handheld devices or from computer (laptop or desktop);
a load balancer instance for handling the said requests received by the said server for routing the said requests to one or more application servers running in parallel and in master-slave mode;
application servers for accepting said requests and advancing processed data from the database servers,
wherein the entire server system being hosted in a cloud-based or dedicated server hosting environment protected by hardware and software firewalls.

30. The system as claimed in claim 29, wherein the application is programmed and automated at a predefined time everyday for updation.

31. The system as claimed in claim 29, wherein multiple instruments may be chosen for display in adjacent ladders for the purpose of comparison.

32. The system as claimed in claim 31, wherein the entire bulk of historical market data up to 12 years and delayed time feed of a plurality of securities is readily made available through the Global Instrument Search Box (GISB) and correlation ladder matrix for display on a display screen ported on different platforms, such as Windows, Android, Apple and Blackberry.
